(19) United States
(12) Patent Application Publication
(10) Pub. No.: US 2021/0271300 A1
(43) Pub. Date: Sep. 2, 2021

(54) DYNAMIC THERMAL CONTROL

(71) Applicant: Hewlett-Packard Development Company, L.P., Spring, TX (US)

(72) Inventors: Yi-Fan Hsia, Taipei City (TW); Chih-Ling Wei, Taipei City (TW); Hung Lung Chen, Taipei City (TW)

(73) Assignee: Hewlett-Packard Development Company, L.P., Spring, TX (US)

(21) Appl. No.: 17/261,584

(22) PCT Filed: Nov. 5, 2018
(86) PCT No.: PCT/US2018/059143

§ 371 Date: Jan. 20, 2021

(51) Int. Cl. G06F 1/20; G05B 15/02

(52) U.S. Cl. CPC G06F 1/206; G06F 2200/201; G05B 15/02

(57) ABSTRACT

In some examples, a system determines a resource load of the electronic device for dynamic thermal control. In response to the resource load exceeding a load threshold, the system activates active cooling in the electronic device based on activation of a fluid flow cooling subsystem to cool the electronic device, and after performing the active cooling, activates component-operation based cooling in response to a temperature in the electronic device exceeding a first temperature threshold.

### BACKGROUND

An electronic device includes various electronic components. Operation of such electronic components can produce heat in the electronic device. A cooling mechanism can be included in the electronic device to dissipate heat from the electronic components. Examples of cooling mechanisms include fans for generating cooling airflows, heat sinks, heat conduits, and so forth.

### BRIEF DESCRIPTION OF THE DRAWINGS

Some implementations of the present disclosure are described with respect to the following figures.

FIG. 1 is a block diagram of an electronic device according to some examples.

FIG. 2 is a flow diagram of a dynamic thermal control process according to some examples.

FIG. 3 is a block diagram of a storage medium storing machine-readable instructions according to some examples.

FIG. 4 is a block diagram of an electronic device according to further examples.

FIG. 5 is a flow diagram of a dynamic thermal control process according to further examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Active cooling in an electronic device involves use of a fluid flow cooling subsystem that generates a fluid flow to carry heat from a heated region in the electronic device to another region, which can be external of the electronic device.

Examples of electronic devices can include any of the foregoing: a desktop computer, a notebook computer, a tablet computer, a server computer, a smartphone, a game appliance, an electronic device in a vehicle, an Internet-of-Things (IoT) device, a communication node, a storage device, or any other type of electronic device that when operated generates heat.

A “fluid flow cooling subsystem” refers to a subsystem that generates a flow of fluid (gas or liquid) that can be used for convective heat transfer. For example, a fluid flow cooling subsystem can include an airflow generator (e.g., a fan or set of fans) that when activated produces a flow of air. The airflow can pass over an electronic component (or multiple electronic components), to carry heat away from the electronic component(s). Alternatively, the airflow can pass over a heat sink that is heated by the heat produced by an electronic component (or multiple electronic components). The heat sink may be directly thermally contacted to an electronic component, or may be thermally coupled to an electronic component using a thermal conduit such as a heat pipe. The airflow can carry heat away from the heat sink.

Activating a fluid flow cooling subsystem to perform active cooling can lead to greater power consumption in the electronic device than when the fluid flow cooling subsystem is inactive.

A different type of cooling that can be performed in an electronic device is based on adjusting an operation of an electronic component. Adjusting an operation of an electronic component can refer to adjusting an operation of a single electronic component or adjusting operations of multiple electronic components. This type of cooling can be referred to as “component-operation based cooling.” An example component-operation based cooling involves throttling an electronic component, such as a processor or a different type of electronic component. Throttling an electronic component can be based on reducing a frequency of operation of the electronic component (or more generally, reducing an activity of the electronic component), which can be accomplished by reducing a frequency of an oscillating clock signal provided to the electronic component, or by reducing the amount of time that the electronic component is active within a specified time window.

Although cooling a system by adjusting an operation of an electronic component avoids the issue of increased power consumption due to activation of a fluid flow cooling subsystem, this cooling technique may lead to reduced system performance, since the electronic component is either run at a lower speed or is inactive for some period of time during a time window. Although power savings can be achieved using component-operation based cooling, this can come at the expense of system performance if the electronic component is throttled to keep a temperature below a temperature threshold.

In some examples, static thermal control can be performed in an electronic device. For example, a static thermal control technique can trigger activation of a fluid flow cooling subsystem in response to a trigger condition, such as a temperature in the electronic device exceeding a temperature threshold. However, in such examples, the fluid flow cooling subsystem may be activated even if the resource load of the computing system is relatively light, which can result in wasted power consumption.

In general, a static thermal control technique uses a predefined or fixed approach of performing cooling in an electronic device. With a static thermal control technique, an electronic device is unable to flexibly adjust how the electronic device performs cooling for different conditions of the electronic device, while attempting to satisfy sometimes inconsistent goals of reduced power consumption and increased system performance.

In accordance with some implementations of the present disclosure, dynamic thermal control can be deployed in an electronic device, to allow for the electronic device to dynamically select different thermal cooling techniques for different conditions of the electronic device. In this manner, the electronic device can select one cooling technique under some conditions to achieve power savings while not significantly sacrificing system performance, and can select a different cooling technique under other conditions to maintain an adequate level of system performance while keeping a temperature in the electronic device below a threshold.

In some examples of the present disclosure, the dynamic thermal control can perform active cooling and component-operation based cooling in different orders depending upon the resource load of an electronic device. A “resource load” of an electronic device refers to an amount of a resource (or multiple resources) consumed by activities in the electronic device, such as by programs executing in the electronic device, operations of hardware processing circuitry, and so forth. A resource load can be a current resource load or a predicted resource load based on current usage.

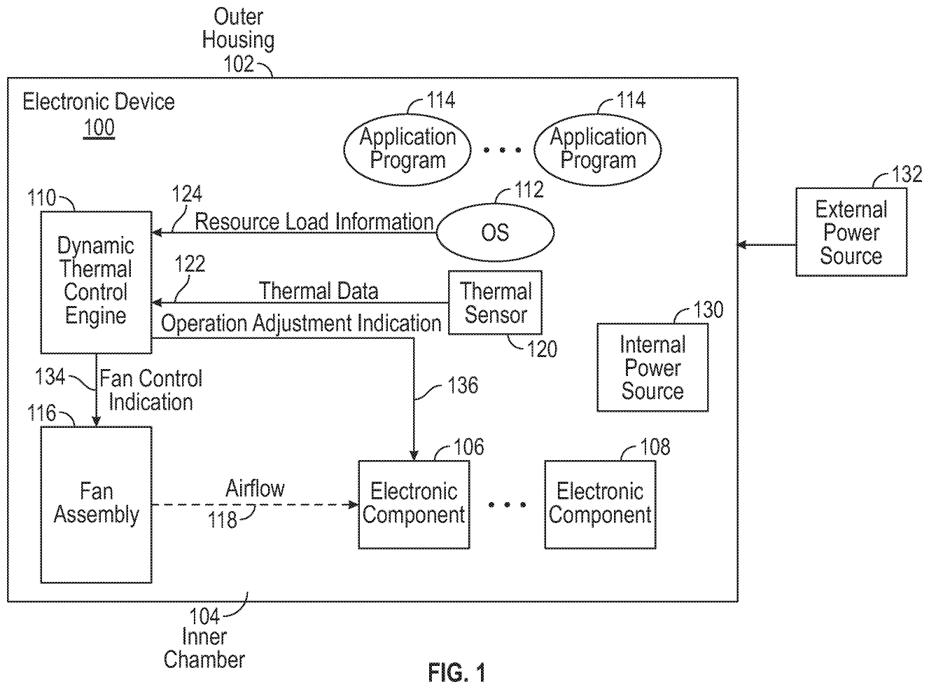

FIG. 1 is a block diagram of an example electronic device 100. The electronic device 100 includes an outer housing 102 that defines an inner chamber 104 in which various components are arranged. The components of the electronic device 100 include electronic components 106 and 108. Although just two electronic components are shown in FIG. 1, it is noted that in other examples, just one electronic component or more than two electronic components can be present. An electronic component can include a processor, a memory device, a storage device, an input/output (I/O) device, and so forth. During operation, the electronic components 106 and 108 can produce heat that is to be dissipated to prevent damage to the electronic components 106 and 108, the electronic device 100, and/or other electronic components.

The electronic device 100 includes a dynamic thermal control engine 110 that is able to perform dynamic thermal control that includes switching between or among multiple different cooling techniques of the electronic device 100 for respective different conditions of the electronic device 100.

As used here, an “engine” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, an “engine” can refer to a combination of a hardware processing circuit and machine-readable instructions (software and/or firmware) executable on the hardware processing circuit.

In some examples, the dynamic thermal control engine 110 can include Basic Input/Output System (BIOS) code or any other type of boot code that controls the initialization of the electronic device 100 in response to power on, reset, or any other initialization of the electronic device 100. The BIOS code or other boot code can be stored in a storage medium such as a flash memory device or other type of memory or storage device, and can be loaded for execution upon initialization of the electronic device 100.

In other examples, the dynamic thermal control engine 110 can include an application program or can be part of an operating system (OS) 112. In further examples, the dynamic thermal control engine 110 can be implemented as a hardware processing circuit.

The OS 112 manages the computing environment of the electronic device 100 in which application programs 114 (and other programs) can execute. Examples of the application programs 114 include a word processing application, a spreadsheet application, an email application, a web browser, and so forth. In other examples, other programs are executable in the electronic device 100, including those for managing the operations of the electronic device 100.

The electronic device 100 also includes a fan assembly 116, which can include a fan (or multiple fans) for producing an airflow 118 when the fan assembly 116 is activated by the dynamic thermal control engine 110. The airflow 118 is used to cool the electronic component 106 and/or the electronic component 108. The fan assembly 116 is an example of a fluid flow cooling subsystem. Although just one fan assembly 116 is shown in FIG. 1, it is noted that in other examples, there can be multiple fan assemblies in the electronic device 100.

A thermal sensor 120 is also provided in the electronic device 100 to measure a temperature in the electronic device 100. The thermal sensor 120 can be used to measure the temperature within a region of the electronic device 100, or alternatively, the thermal sensor 120 can be used to measure a temperature of an electronic component, such as the electronic component 106 and/or electronic component 108. To measure a temperature of an electronic component, the thermal sensor 120 can be part of or be thermally coupled to the electronic component.

The thermal sensor 120 provides thermal data 122 to the dynamic thermal control engine 110. The thermal data 122 is based on a measurement made by the thermal sensor 120. The thermal data 122 provides an indication of a temperature in the electronic device 100. For example, the thermal data 122 can include the temperature, or can include other data from which the dynamic thermal control engine 110 is able to derive the temperature.

Although just one thermal sensor 120 is shown in FIG. 1, it is noted that in other examples, there can be multiple thermal sensors, which can be used to make thermal measurements of one region or of multiple regions in the electronic device 100, or of one electronic component or multiple electronic components in the electronic device 100.

The dynamic thermal control engine 110 can further receive resource load information 124 from the OS 112. In some examples, the OS 112 is able to monitor an amount of a resource (or resources) of the electronic device 100 that each application program 114 (or another program) is utilizing. For example, a resource can include a processing resource. A processing resource can include a processor or multiple processors. A processor can include a microprocessor, a core of a multi-core microprocessor, a microcontroller, a programmable integrated circuit, a programmable gate array, a digital signal processor, or another hardware processing circuit.

The OS 112 can also monitor utilization by programs of other resources, including storage resources, communication resources, and so forth. A storage resource can include a resource to store data, such as a memory device (or multiple memory devices) and/or a storage device (or multiple storage devices). A communication resource can include a resource to communicate data, such as a network interface controller (NIC), or multiple NICs.

The resource load information 124 can provide information regarding usage by each program of the resource(s) of the electronic device 100. For example, for a processing resource, the resource load information 124 can specify a percentage of the processing resource utilized by each respective program (e.g., program 1 is currently using 10% of the processing resource, program 2 is currently using 1% of the processing resource, program 3 is currently using 0.1% of the processing resource, etc.).

In other examples, the resource load information 124 can include a different metric to express either a current usage of the processing resource or a predicted usage of the processing resource in a time window during which thermal control is to be performed. For example, a first program that is currently using 20% of the processing resource can be assigned a first expected load level by the OS 112 that is higher than a second expected load level assigned by the OS 112 to a second program that is currently using 1% of the processing resource. More generally, multiple expected load levels (or multiple expected load values) can represent different expected consumption of the processing resource by respective programs.

In alternative examples, the resource load information 124 can be based on both (1) resource utilization by programs and (2) a level of user interaction with the programs. For example, the OS 112 can detect whether a user is currently actively interacting with a given program. If a user is currently actively interacting with a given program, then that provides an indication that the expected load level would be higher than if a user is not currently actively interacting with the given program. Whether or not a user is currently actively interacting with the given program can be based on whether the given program is in focus in a graphical user interface (GUI). Multiple windows for different programs may be launched by the electronic device 100. A user can select one of the multiple windows to interact with, which brings the selected window into focus. The program associated with the selected window is the program in focus. The program in focus is considered by the OS 112 as the program that the user is currently actively interacting with.

Table 1 below sets forth an example mapping between an expected load level and a combination of a resource utilization and user interaction level for a program.

TABLE 1

| Resource utilization | User interaction | Expected load level |
|---|---|---|
| 20% utilization of a | User is currently actively | 5 |
| resource by the program | interacting with the | |
| | program | |
| 20% utilization of the | User is not interacting | 2 |
| resource by the program | with the program | |
| 5% utilization of the | User is currently actively | 3 |
| resource by the program | interacting with the | |
| | program | |
| 5% utilization of the | User is not interacting | 1 |
| resource by the program | with the program | |

In the example given, a higher expected load level has a higher numerical value.

In the first row of the table, if the program is currently using 20% of the resource, and the user is currently actively interacting with the program, then the OS 112 can assign an expected load level of 5. On other hand, as set forth in the second row of the table, if the program is currently using 20% of the resource, and the user is not interacting with the program, then the OS 112 can assign a lower expected load level of 2 (e.g., even though the program is currently using 20% of the resource, the program is not expected to increase its activity since the user is not currently interacting with the program). In the third row, if the program is currently using 5% of the resource, and the user is currently actively interacting with the program, then the OS 112 can assign an expected load level of 3. In the fourth row, if the program is currently using 5% of the resource, and the user is not interacting with the program, then the OS 112 can assign a lower expected load level of 1.

Other examples can be used to assign an expected load level based on resource utilization and user activity.

In further examples, the resource load information 124 can express current or expected usage of a resource in other ways.

Also, instead of using the OS 112 to provide the resource load information 124 to the dynamic thermal control engine 110, a different entity (e.g., an application program, a management program, a hardware controller, etc.) can monitor usage of a resource (or resources) of the electronic device 100 (and possibly user activity) and can provide the resource load information 124 based on the monitoring.

The dynamic thermal control engine 110 is able to dynamically select one of multiple cooling techniques to use for cooling the electronic device 100 based on a detected condition of the electronic device 100, which can be indicated by the resource load information 124 and a type of power source used to power the electronic device 100, for example.

The electronic device can be powered by an internal power source 130 of the electronic device 100 or an external power source 132. For example, the internal power source 130 can include a battery or some other type of power source in the electronic device 100. The external power source 132 is a power source that is external of the electronic device 100, such as a wall outlet, an external battery, or other power source.

The different cooling techniques selectable by the dynamic thermal control engine 110 can involve implementation of different orders active cooling and component-operation based cooling. For example, with a first cooling technique, the dynamic thermal control engine 110 can first apply active cooling followed by component-operation based cooling if the active cooling is insufficient for maintaining a temperature in the electronic device 100 below a first temperature threshold. A second cooling technique can use a different order in which component-operation based cooling is first applied and active cooling is activated if the component-operation based cooling is unable to maintain a temperature of the electronic device 100 below a temperature threshold.

To implement active cooling, the dynamic thermal control engine 110 can control the fan assembly 116 using a fan control indication 134. The fan control indication 134 can include a signal, a command, an information element, and so forth, which can have different values or states to respectively activate or deactivate the fan assembly 116, and/or to control a setting (e.g., a high setting, a medium setting, a low setting, etc.) of the fan assembly 116.

Also, the dynamic thermal control engine 110 can perform component-operation based cooling by providing an operation adjustment indication 136 to control the operation of the electronic component 106. Adjusting an operation of the electronic component 106 can refer to changing a speed (or frequency) at which the electronic component 106 is operating, changing an amount of time that the electronic component 106 is active versus inactive during a time interval, or any other control where the activity of the electronic component 106 can be adjusted. Reducing the activity level of the electronic component 106 reduces the power consumption of the electronic component 106, which in turn can reduce the amount of heat produced by the electronic component 106. Increasing the activity of the electronic component 106 can increase the power consumption of electronic component 106, which in turn can increase the amount of heat produced by the electronic component 106.

Although FIG. 1 shows an example where the dynamic thermal control engine 110 provides the operation adjustment indication 136 to adjust the electronic component 106, it is noted that in other examples, the dynamic thermal control engine 110 can provide multiple operation adjustment indications to control operations of respective multiple electronic components. The operation adjustment indication 136 can include a signal, a command, an information element, and so forth, which can have different values or states to set the electronic component 106 at different respective activity levels.

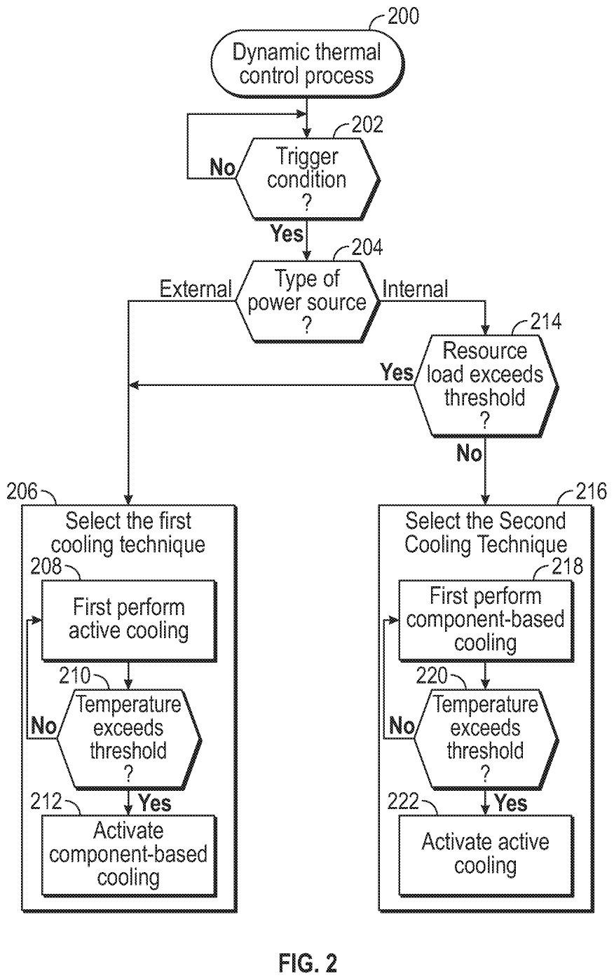

FIG. 2 is a flow diagram of a dynamic thermal control process 200 according to some implementations of the present disclosure, which can be performed by the dynamic thermal control engine 110.

Although FIG. 2 shows a specific order of tasks, it is noted that in other examples, a dynamic thermal control process can use a different order of the tasks or can use other tasks.

The dynamic thermal control process 200 determines (at 202) whether a trigger condition has been satisfied. The trigger condition can include a detected temperature in the electronic device 100 (such as a temperature detected based on the thermal data 122 from the thermal sensor 120) exceeding a trigger temperature. If the trigger condition is not satisfied (such as the temperature being less than the trigger temperature), then the dynamic thermal control process 200 does not activate any cooling technique.

However, if the trigger condition is satisfied, the dynamic thermal control process 200 determines (at 204) the type of power source used to power the electronic device 100, e.g., whether the electronic device 100 is powered by the internal power source 130 or the external power source 132. In response to determining that the electronic device 100 is powered by the external power source 132, the dynamic thermal control process 200 selects (at 206) the first cooling technique. With the first cooling technique, the dynamic thermal control engine 110 first performs (at 208) active cooling by activating the fan assembly 116 using the fan control indication 134 (FIG. 1). First performing active cooling means that active cooling is first activated while component-operation based cooling remains inactive.

After activating the fan assembly 116 while the component-operation based cooling remains inactive, the dynamic thermal control engine 110 determines (at 210) whether the temperature in the electronic device 100 (such as the temperature detected based on the thermal data 122 from the thermal sensor 120) exceeds a temperature threshold (which is higher than the trigger temperature). If not, the dynamic thermal control engine 110 continues to use active cooling. However, if the temperature in the electronic device 100 exceeds the temperature threshold (which means that the active cooling is insufficient to maintain adequate cooling), then the dynamic thermal control engine 110 activates (at 212) component-operation based cooling, by using the operation adjustment indication 136 (FIG. 1) to control the activity level of the electronic component 106 (e.g., by throttling the electronic component 106).

Although not shown in FIG. 2, after activating the component-operation based cooling, the first cooling technique can then check to see if the temperature in the electronic device 100 falls below the temperature threshold; if so, the component-operation based cooling can be deactivated (in other words, the activity level of the electronic component 106 is not reduced, such as by removing throttling of the electronic component 106). Also, when using the first cooling technique, if the temperature in the electronic device 100 falls below the trigger temperature, then active cooling can also be deactivated.

If the dynamic thermal control process 200 determines (204) that the electronic device 100 is powered by the internal power source 130 (and not by the external power source 132), the dynamic thermal control process 200 determines (at 214) whether a resource load (as indicated by the resource load information 124 in FIG. 1) of the electronic device 100 exceeds a resource load threshold.

As a specific example, the dynamic thermal control engine 110 can submit a query to the OS 112 for the resource load information 124, and the OS 112 can respond to this query with the resource load information 124. Alternatively, the OS 112 can store the resource load information 124 in a storage medium, which is accessible by the dynamic thermal control engine 110 to retrieve the resource load information 124.

In response to determining that the resource load exceeds the resource load threshold, the dynamic thermal control process 200 selects (at 206) the first cooling technique. On the other hand, in response to determining that the resource load does not exceed the resource load threshold, the dynamic thermal control process 200 selects (at 216) the second cooling technique. The second cooling technique first performs (at 218) component-operation based cooling using the operation adjustment indication 136 to control the activity level of the electronic component 106. First performing component-operation based cooling means that component-operation based cooling is first activated while active cooling (the fan assembly 116) remains inactive.

After activating the component-operation based cooling while the active cooling remains inactive, the dynamic thermal control engine 110 determines (at 220) whether the temperature in the electronic device 100 exceeds a temperature threshold. Note that the temperature threshold used in task 220 can be the same as or different from the temperature threshold used in task 210. If the temperature does not exceed the temperature threshold, the dynamic thermal control engine 110 continues to use component-operation based cooling. However, if the temperature in the electronic device 100 exceeds the temperature threshold (which means that the component-operation based cooling is insufficient to maintain adequate cooling), the dynamic thermal control engine 110 activates (at 222) active cooling, by using the fan control indication 134 (FIG. 1) to control the fan assembly 116.

Although not shown in FIG. 2, after activating the component-operation based cooling, the second cooling technique can then check to see if the temperature in the electronic device 100 falls below the temperature threshold; if so, the active cooling can be deactivated (by deactivating the fan assembly 116). Also, when using the second cooling technique, if the temperature in the electronic device 100 falls below the trigger temperature, then component-operation based cooling can also be deactivated.

Generally, with the first cooling technique, active cooling is first performed, followed by component-operation based cooling if the active cooling is insufficient to maintain the temperature below the temperature threshold. With the second cooling technique, component-operation based cooling is first performed, followed by active cooling if the component-operation based cooling is insufficient to maintain the temperature below the temperature threshold.

The first cooling technique can consume more power than the second cooling technique, since the first cooling technique first uses active cooling followed by component-operation based cooling. By using the first cooling technique when powered by the external power source 132, overall performance of the electronic device 100 can be enhanced since the active cooling is first attempted so that reduction of the activity level of an electronic component caused by component-operation based cooling is not used if the temperature remains below the temperature threshold. By using the second cooling technique when the electronic device 100 is powered by the internal power source 130 and the resource load does not exceed the resource load threshold, power savings can be achieved to extend the life of the internal power source 130.

Although the example of FIG. 2 shows just two cooling techniques, it is noted that additional cooling technique(s) different from the first and second cooling techniques can also be used by the dynamic thermal control process 200, based on a detected condition of the electronic device 100. The detected condition can be indicated by any combination of a type of power source used to power the electronic device 100, the resource load of the electronic device 100, or the temperature of the electronic device 100.

In some examples, the resource load indicated by the resource load information 124 can be based on aggregating (e.g., summing, averaging, etc.) respective resource loads of multiple programs (e.g., multiple application programs 114). As explained above in connection with Table 1, in some examples, a resource load associated with a program can be expressed as an expected load level.

Table 2 below shows an example of an aggregate load level that is based on aggregating expected load levels of multiple programs.

TABLE 2

| | Expected Load Level |
|---|---|
| Program 1 | 4 |
| Program 2 | 1 |
| Program 3 | 2 |
| Aggregate Load Level | 7 |

As explained in connection with Table 1, in some examples, the load level of each program is based on the combination of utilization of a resource and user activity relative to the program. The aggregate load level in Table 2 is a sum of the expected load levels for programs 1, 2, and 3. The aggregate load level of Table 2 is an example of the resource load that is compared to the resource load threshold in task 214 of FIG. 2. If the resource load threshold is 6, for example, then the aggregate load level of 7 would exceed the resource load threshold, which can trigger the selection (at 216) of the second cooling technique in FIG. 2.

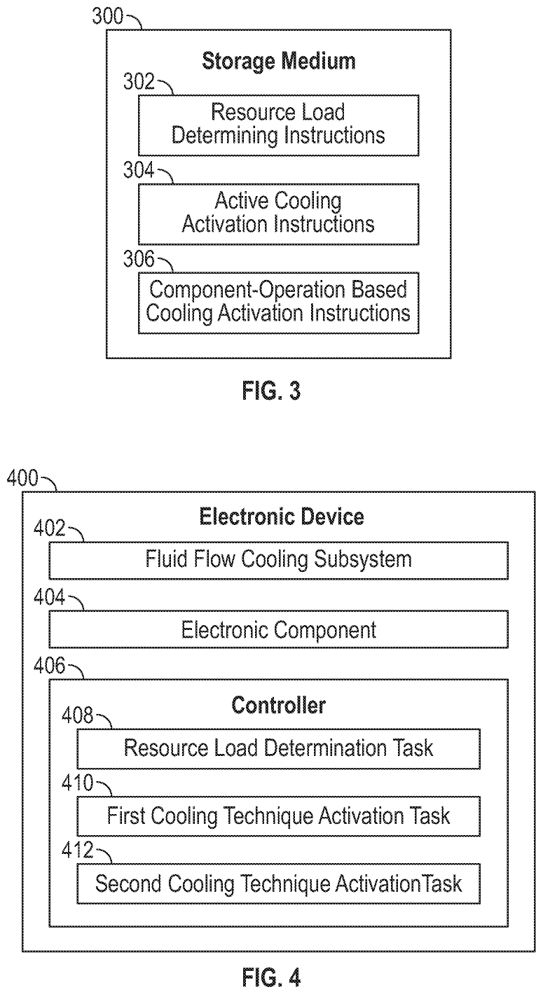

FIG. 3 is a block diagram of a non-transitory machine-readable or computer-readable storage medium 300 storing machine-readable instructions that upon execution cause a controller (e.g., the dynamic thermal control engine 110 of FIG. 1) of an electronic device to perform various tasks.

The machine-readable instructions include resource load determining instructions 302 to determine a resource load of the electronic device for dynamic thermal control. The machine-readable instructions further include active cooling activation instructions 304 and component-operation based cooling activation instructions 306 that are executed in response to the resource load exceeding a resource load threshold. In response to the resource load exceeding the resource load threshold, active cooling activation instructions 304 activate active cooling in the electronic device based on activation of a fluid flow cooling subsystem to cool the electronic device. After performing the active cooling, the component-operation based cooling activation instructions 306 activate component-operation based cooling in response to a temperature in the electronic device exceeding a first temperature threshold, the component-operation based cooling including an adjustment to an operation of an electronic component of the electronic device (e.g., by throttling the electronic component).

After performing the active cooling, the component-operation based cooling activation instructions 306 decline to activate the component-operation based cooling in response to the temperature not exceeding the first temperature threshold.

FIG. 4 is a block diagram of an electronic device 400 that includes a fluid flow cooling subsystem 402 to generate a cooling fluid flow in the electronic device 400, an electronic component 404, and a controller 406 to perform various tasks.

The tasks of the controller 406 include a resource load determination task 408 to determine a resource load of the electronic device for dynamic thermal control. The tasks further include a first cooling technique activation task 410 to, in response to the resource load exceeding a load threshold, activate the first cooling technique. The first cooling technique first activates active cooling in the electronic device, and in response to detecting a temperature in the electronic device exceeding a temperature threshold after the active cooling is activated, activates component-operation based cooling.

The tasks of the controller 406 further include a second cooling technique activation task 412 to, in response to the resource load being less than or equal to the load threshold, activate a second cooling technique. The second cooling technique first activates the component-operation based cooling, and in response to detecting the temperature in the electronic device exceeding the temperature threshold after the component-operation based cooling is performed, activates the active cooling.

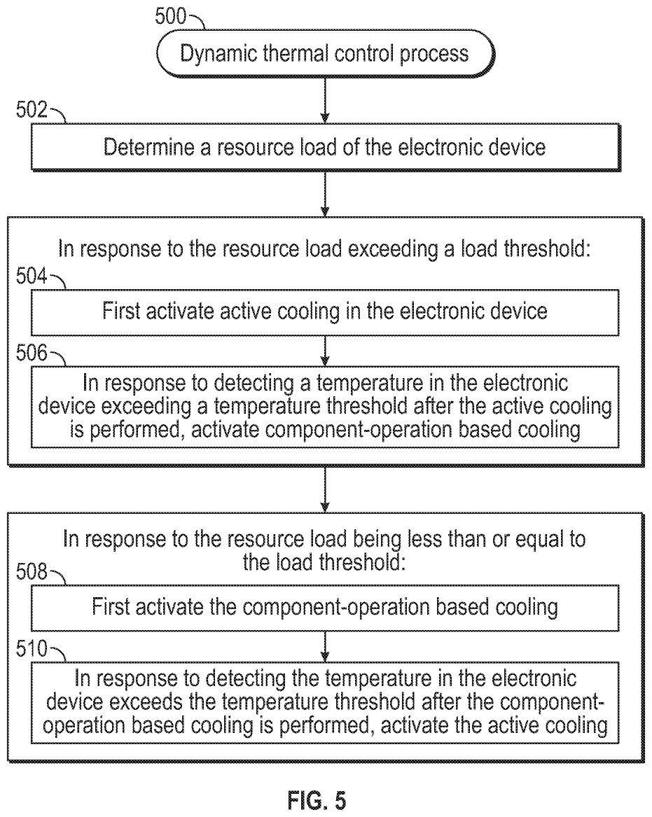

FIG. 5 is a flow diagram of a dynamic thermal control process 500 according to further examples, which can be performed by a controller such as the dynamic thermal control engine 110 of FIG. 1. Although FIG. 2 shows a specific order of tasks, it is noted that in other examples, a dynamic thermal control process can use a different order of the tasks or can use other tasks.

The dynamic thermal control process 500 determines (at 502) a resource load of the electronic device. In response to the resource load exceeding a load threshold, the dynamic thermal control process 500 first activates (at 504) active cooling in the electronic device, and in response to detecting a temperature in the electronic device exceeding a temperature threshold after the active cooling is performed, activates (at 506) component-operation based cooling, the active cooling based on activation of a fluid flow cooling subsystem, and the component-operation based cooling comprising throttling the electronic component.

In response to the resource load being less than or equal to the load threshold, the dynamic thermal control process 500 first activates (at 508) the component-operation based cooling, and in response to detecting the temperature in the electronic device exceeds the temperature threshold after the component-operation based cooling is performed, activates (at 510) the active cooling.

The storage medium 300 of FIG. 3 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium storing instructions that upon execution cause a controller of an electronic device to:
determine a resource load of the electronic device for dynamic thermal control; and
in response to the resource load exceeding a load threshold:
activate active cooling in the electronic device based on activation of a fluid flow cooling subsystem to cool the electronic device, and
after performing the active cooling, activate component-operation based cooling in response to a temperature in the electronic device exceeding a first temperature threshold, the component-operation based cooling comprising an adjustment to an operation of an electronic component of the electronic device.

2. The non-transitory machine-readable storage medium of claim 1, wherein the fluid flow cooling subsystem comprises an airflow generator.

3. The non-transitory machine-readable storage medium of claim 1, wherein the instructions upon execution cause the controller to adjust the operation of the electronic component in the component-operation based cooling by throttling the electronic component.

4. The non-transitory machine-readable storage medium of claim 1, wherein the instructions upon execution cause the controller to:
after performing the active cooling in response to the resource load exceeding the load threshold, decline to activate the component-operation based cooling in response to the temperature not exceeding the first temperature threshold.

5. The non-transitory machine-readable storage medium of claim 1, wherein the instructions upon execution cause the controller to:
in response to the resource load not exceeding the load threshold:
perform the component-operation based cooling to control the temperature in the electronic device based on adjusting the operation of the electronic component while the fluid flow cooling subsystem is inactive.

6. The non-transitory machine-readable storage medium of claim 5, wherein performing the component-operation based cooling while the fluid flow cooling subsystem is inactive is responsive to the temperature in the electronic device not exceeding a second temperature threshold.

7. The non-transitory machine-readable storage medium of claim 6, wherein the instructions upon execution cause the controller to:
after performing the component-operation based cooling while the fluid flow cooling subsystem is inactive, perform the active cooling based on the activation of the fluid flow cooling subsystem in response to the temperature in the electronic device exceeding the second temperature threshold.

8. The non-transitory machine-readable storage medium of claim 1, wherein the instructions upon execution cause the controller to:
determine the resource load of the electronic device based on activity of a program executing in the electronic device.

9. The non-transitory machine-readable storage medium of claim 8, wherein the instructions upon execution cause the controller to:
determine the resource load of the electronic device further based on user interaction with the program.

10. An electronic device comprising:
a fluid flow cooling subsystem to generate a cooling fluid flow in the electronic device;
an electronic component;
a controller to:
determine a resource load of the electronic device for dynamic thermal control;
in response to the resource load exceeding a load threshold:
first activate active cooling in the electronic device, and in response to detecting a temperature in the electronic device exceeding a temperature threshold after the active cooling is activated, activate component-operation based cooling, the active cooling based on activation of the fluid flow cooling subsystem, and the component-operation based cooling comprising an adjustment to an operation of the electronic component; and
in response to the resource load being less than or equal to the load threshold:
first activate the component-operation based cooling, and in response to detecting the temperature in the electronic device exceeding the temperature threshold after the component-operation based cooling is performed, activate the active cooling.

11. The electronic device of claim 10, wherein the controller is to determine the resource load of the electronic device based on activities of programs in the electronic device.

12. The electronic device of claim 10, wherein the controller is to determine the resource load of the electronic device based on respective levels of user interactions with programs in the electronic device.

13. The electronic device of claim 10, wherein the controller is to first activate active cooling in the electronic device in response to detecting that the electronic device is powered by an external power source, and first activate the component-operation based cooling in the electronic device in response to detecting that the electronic device is powered by an internal power source and the resource load being less than or equal to the load threshold.

14. A method of performing dynamic thermal control in an electronic device comprising an electronic component, the method comprising:
determining, by a controller, a resource load of the electronic device;
in response to the resource load exceeding a load threshold:
first activating, by the controller, active cooling in the electronic device, and in response to detecting a temperature in the electronic device exceeding a temperature threshold after the active cooling is performed, activating, by the controller, component-operation based cooling, the active cooling based on activation of a fluid flow cooling subsystem, and the component-operation based cooling comprising throttling the electronic component; and
in response to the resource load being less than or equal to the load threshold:
first activating, by the controller, the component-operation based cooling, and in response to detecting the temperature in the electronic device exceeds the temperature threshold after the component-operation based cooling is performed, activating, by the controller, the active cooling.

15. The method of claim 14, wherein first activating the component-operation based cooling is in response to detecting that the electronic device is powered by an internal power source of the electronic device and the resource load being less than or equal to the load threshold.
